(19) United States
(12) Patent Application Publication
(10) Pub. No.: US 2008/0247379 A1
(43) Pub. Date: Oct. 9, 2008

(54) Method and Network for Managing an Interface for Session-Based Synchronization

(75) Inventors: Philippe Belanger, Laval (CA); Hakan Osterlund, Ekero (SE)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/697,127

(22) Filed: Apr. 5, 2007

(51) Int. Cl. H04L 12/28

(52) U.S. Cl. 370/351

(57) ABSTRACT

A method and network node for supporting a synchronization of a connectivity session location function (CLF) in a communication network. The method uses a processor for sending and receiving messages from a communication network, detecting the unavailability of the CLF, detecting that access information related to the session of the UE is missing from the CLF, receiving missing access information for a session of a UE and synchronizing the CLF on a per session basis. Furthermore, the processor accesses a memory for storing access information and synchronizes the stored access information of the session with the received missing access information of the session of the UE stored during unavailability of the CLF.

### TECHNICAL FIELD

The present invention generally relates to communication systems and methods and, more particularly, to mechanisms and techniques for updating the content of a network entity.

### BACKGROUND

Communication systems continue to grow and evolve. Convergence between different types of communication systems, e.g., Internet Protocol (IP), connection-based voice communications, and the like, is advancing rapidly. Recently the phrase “Next Generation Network” (NGN) has been used to describe various activities associated with this evolution. As defined by the International Telecommunications Union (ITU), an NGN is a packet-based network able to provide services (including telecommunication services) and able to make use of multiple broadband, QoS-enabled transport technologies and in which service-related functions are independent from underlying transport-related technologies. NGNs will also likely offer unrestricted access by users to different service providers and will support generalized mobility, which in turn will provide for consistent service provision to end users.

Various standardization groups are working on reaching a consensus regarding the technology considerations which will affect NGN design and implementation. For example, Telecoms & Internet converged Services & Protocols for Advanced Networks (TISPAN) is an ETSI standardization group which focuses on convergence of technologies used in the Internet and other fixed networks. Among other things, TISPAN seeks to provide a modular, subsystem-oriented architecture which facilitates the addition of new subsystems over time to cover new demands and service classes. The TISPAN architecture attempts to ensure that network resources, applications, and user equipment are common to all of the various subsystems to provide for enhanced mobility across, for example, administrative boundaries.

One of the TISPAN subsystems is referred to as the Network Attachment Sub System (NASS). The NASS is responsible for, among other things, handling configuration information, user authentication data, IP address allocation and registering associations between IP addresses allocated to user equipment (UE) and related network location information. These latter two NASS functions, i.e., allocating IP addresses and registering associations, are handled by the Network Access Configuration Function (NACF) and the Connectivity Session Location and Repository Function (CLF), respectively, which are functional entities that are also specified by the NASS portion of the TISPAN standards.

These NASS functional entities interact with another TISPAN subsystem known as the Resource Admission Control Subsystem (RACS) and the Access Resource and Admission Control Function (A-RACF) functional entity of the RACS. The A-RACF functional entity, among other things, receives information about the IP address allocated to a particular user and maps that IP allocation to physical resources in the access network. Each A-RACF is, in these exemplary embodiments, associated with a Session Border Controller (SBC). An SBC interacts directly with the network elements that provide communication services to an end user, e.g., Digital Subscriber Line Access Multiplexers (DSLAMs).

In the TISPAN network model, the NACF-CLF interface, which is defined as an a2 interface, identifies a set of primitive used to accomplish the tasks associated with the exchange of information between the two nodes. The a2 interface supports the Bind Indication, Bind Acknowledgment and Unbind Indication. These primitives are used to send the binding information between the IP Address and network specific data. This data can be used to lookup the data in the CLF and associate the binding to location information for instance. However, the interface only provides a PUSH interface where the information is meant to flow only from the NACF to the CLF. In this case, the CLF cannot synchronize its data efficiently since it would require sending the entire NACF database over the a2 as a possible synchronization alternative because the interface does not include the necessary primitives to perform that function.

One problem associated with these primitives is that these primitives are push only and does not take into account re-synchronizations needs, which are required in any system with HA requirements. These synchronization scenarios are quite complex and it becomes apparent that a push only interface will not solve all the problems, because the CLF does not know when the data has changed on the NACF resulting in a PULL for each request. A PULL only interface does not solve all problems as it lacks the ability for the NACF to notify the CLF of changes that is occurring at that time.

Accordingly, it would be desirable to have a mechanism for allowing the CLF to synchronize its data with the NACF after unavailability of the CLF.

### SUMMARY

It is a broad aspect of the present invention to provide a method for supporting a synchronization of a connectivity session location function (CLF) in a communication network, the method comprising steps of:

detecting the unavailability of the CLF;

storing access information related to a session of a user equipment (UE), at a network access configuration function (NACF), during the unavailability of the CLF;

recovering network node capabilities at the CLF;

receiving from a network node a request for retrieving access information for the session of the UE;

detecting that access information related to the session of the UE is missing from the CLF;

sending an access information request to the NACF for retrieving the missing access information for the session of the UE;

receiving an acknowledgement message from the NACF, the acknowledgment message including the missing access information for the session of the UE; and

synchronizing the CLF for the session of the UE.

It is another broad aspect of the present invention to provide a network node for synchronizing access information between a network node and a communication network following an unavailability of the network node, the network node comprising:

a processor for sending and receiving messages from a communication network, detecting the unavailability of a connectivity session location function (CLF), detecting that access information related to the session of the UE is missing from the CLF, receiving missing access information for a session of a user equipment (UE) and synchronizing the CLF for the session of the UE; and

wherein the processor accesses a memory for storing access information and synchronizes the stored access information for the session with the received missing access information stored during unavailability of the CLF.

### BRIEF DESCRIPTION OF THE DRAWINGS

The foregoing and other aspects, features, and advantages of the invention will be apparent from the following more particular detailed description as illustrated in the accompanying drawings in which reference characters refer to the same parts throughout the various views. The drawings are not necessarily to scale, emphasis instead being placed upon illustrating the principles of the invention.

FIG. 1 is a schematic diagram illustrating a communication network for providing Internet Protocol (IP) services to a user equipment (UE) in accordance to the invention;

FIG. 2 is a schematic diagram illustrating a network node for managing access information for UEs and queries made from other network node in the communication network, in accordance to the invention;

FIG. 3 illustrates the steps of a method for synchronizing a CLF after unavailability of the CLF, in accordance to the invention; and

FIG. 4 is an example of a list of parameters related to access information stored at a CLF and to be updated for a UE, in accordance to the invention.

### DETAILED DESCRIPTION

In the following description, for purposes of explanation and not limitation, specific details are set forth such as particular architectures, interfaces, techniques. In order to provide a thorough understanding of the present invention. However, it will be apparent to those skilled in the art that the present invention may be practiced in other embodiments that depart from these specific details. In other instances, detailed descriptions of well known devices, circuits, and methods are omitted so as not to obscure the description of the present invention with unnecessary detail.

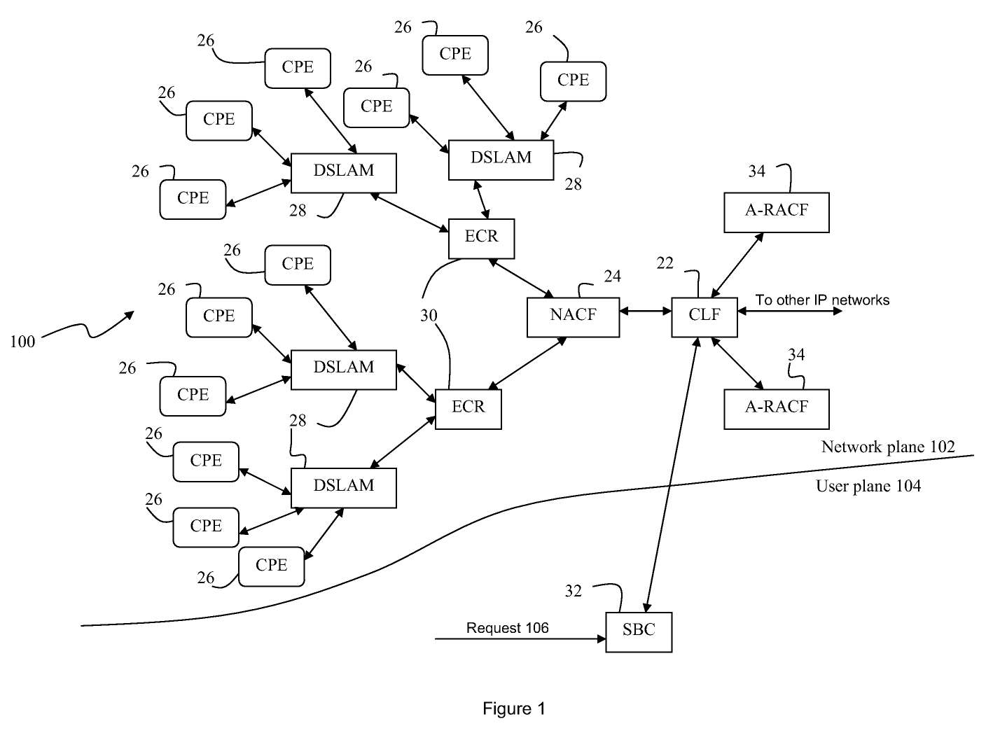

In order to provide some context within which exemplary embodiments will be better understood, consider the exemplary portion of a communication network 100 illustrated as FIG. 1. It will be appreciated by those skilled in the art that this example is purely illustrative and that exemplary embodiments may be implemented in many types of networks other than the example provided as FIG. 1. Therein, the portion of the communication network associated with a network plane 102 and the user plane 104 is illustrated. Other network planes (not shown) may also be supported in, e.g., their resource allocation functions, by the CLF 22 and NACF 24. The CLF 22 and NACF are described as standalone network node, but they can alternatively be combined and in a single network node.

To briefly step through the exemplary network structure illustrated in FIG. 1, a number of consumer premise equipments (CPEs) 26, sometimes also referred to as “user equipments (UEs)”, are connected to the network through a digital subscriber line access multiplexer (DSLAM) 28. The DSLAMs 28 multiplex signals from the CPEs 26 together and load them onto the network via an edge collect router (ECR) 30. Communications between the end user and the network 100 are passed between the ECR 30 and a session border controller (SBC) 32. The SBC 32 operates as a gateway device between the end user (CPE 26) and the network 100 and can transmit and receive messages including information associated with a location information query for, e.g., 911 purposes. The NACF 24 is a DHCP server from which the ECR 30 requests an IP address, via a DHCP request along with Option 82 parameters, for the associated CPE 26 which has attached to the network. This IP address is allocated from a subnet pool configured in the NACF 24. Once the IP address is allocated and returned to the ECR 30, then NACF 24 can then push this Network Attach information along with the location of the associated CPE 26 to the CLF 22, which acts as a session data repository for CPEs 26. A session establishes an association, which is performed for example by the CLF 22, between an IP address allocated to the CPE and other information e.g. network location information. The SBC 32 interfaces with the rest of, for example, an IP backbone network (not shown) to, for example, interconnect a CPE 26 with another device, website, etc.

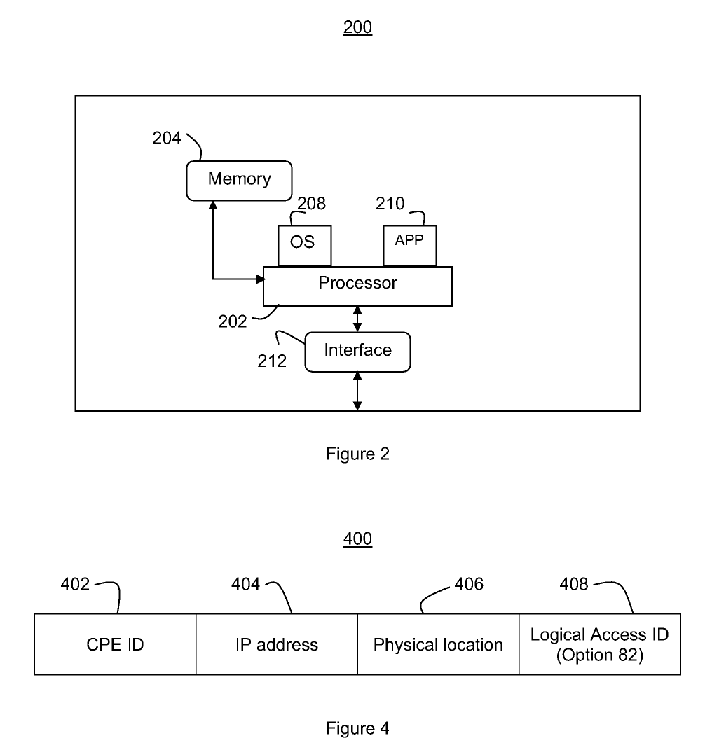

The implementation of a push/pull interface or the like according to these exemplary embodiments can impact, among other things, the CLF 22 and NACF 24 entities within the communication network 100. Structurally, the CLF 22 and NACF 24 can, for example, each be implemented in hardware and software as servers. For example, as shown generally in FIG. 2, such a server 200 can include a processor 202 (or multiple processor cores), memory 204, an operating system 208 running on the processor 204 and using the memory 204, as well as a corresponding application 210, e.g., a CLF application for the CLF server and an NACF application for the NACF server. An interface unit 212 may be provided to facilitate communications between the network node 200 and the rest of the network 100 (interface e4) or between the CLF 22 and the NACF 24 (interface a2). The interface unit 212 may also be integrated into the processor 202. Thus, a network node 200 according to an exemplary embodiment may include a processor 202 for transmitting and receiving messages associated with at least one of location of user equipment and IP address allocation to a user equipment (CPE).

While FIG. 2 is generic to, for example, a CLF network node or a NACF network node, the specific messages which are transmitted and received according to these exemplary embodiments will vary by, for example, the type of node under consideration. For example, a CLF network node 200 can operate to register an association between an IP address allocated to the user equipment and network location information and can, therefore, transmit messages to the network over an a2 interface and receive messages from the network 100 over an e4 interface. The messages may include information associated with at least one of: initial gate setting, list of allowed destinations, uplink subscribed bandwidth, downlink subscribed bandwidth, QoS profile information, transport service class, media type, maximum priority and requestor name, among other things.

Similarly, an NACF network node 200 operates to verify that bandwidth needed for services requested by particular IP address allocation to a particular CPE 26. The NACF 24 may also distribute other network configuration parameters. The NACF 24 can transmit messages to the network over an a2 interface and receive messages from the network 100 over an e4 interface. The messages may include information associated with at least one of: initial gate setting, list of allowed destinations, uplink subscribed bandwidth, downlink subscribed bandwidth, QoS profile information, transport service class, media type, maximum priority and requestor name.

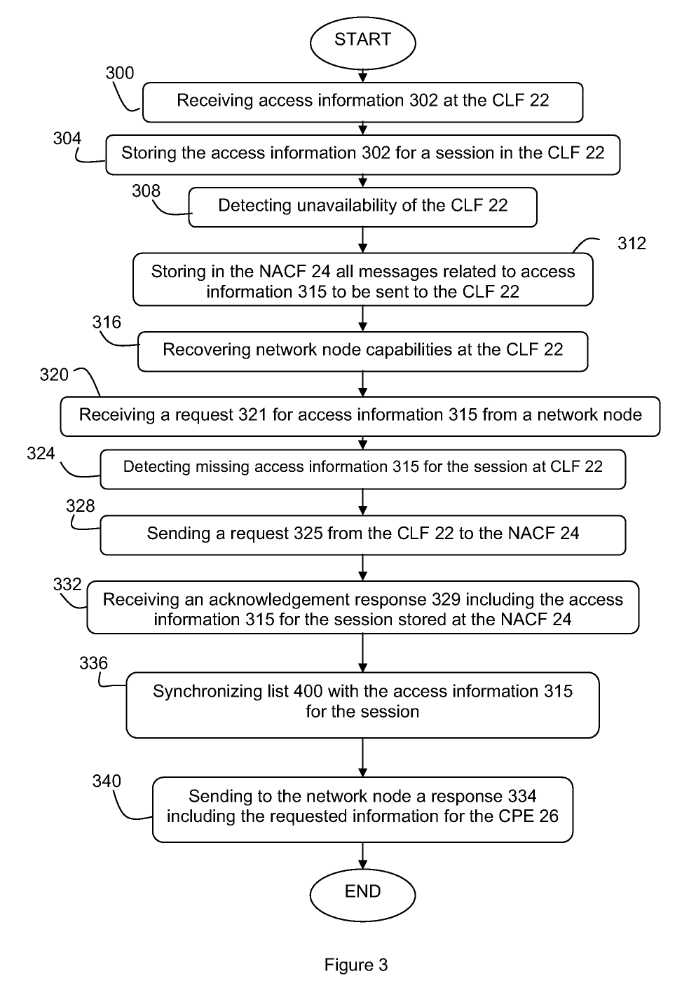

Reference is now made to FIG. 3, which illustrates the steps of a method for re-synchronizing a CLF 22 after failure because of an outage, an overload of the processing or after maintenance of the CLF 22, in accordance to an exemplary embodiment of the invention. Reference is also made to FIG. 4, which is a list of CPEs 26 connected to DSLAM 28 associated to the portion of the network 100 as illustrated in FIG. 1.

At step 300, the CLF 22 receives access information 302 for a session of a CPE 26 consisting of, while not being limited to these parameters, the IP address 404 of the CPE 26, Logical Access identifier (ID) 408, CPE ID 402 and other parameters present in Option 82 parameters such as the Physical location 406 of the CPE 26. Upon reception of the access information 302 for a CPE 26, the CLF 22 stores in the list 400 this access information or updates the list 400. The CLF 22 may become unavailable due to failure or for maintenance operations of the CLF 22 (step 304). When such unavailability of the CLF 22 is detected at the CLF (processor 202) or at the NACF (step 308), the NACF 24 stores all messages related to the new access information 315 for the session of the CPE 26, which is to be sent to the unavailable CLF 22 (step 312). More particularly, during the synchronous mode (availability of the CLF 22), the NACF 24 assigns an IP address to each CPE 26. When there is no response from the CLF 22, the Network Attachment can be successful but the new binding information (access information 315) is not pushed to the CLF 22. Alternatively, during the asynchronous mode (unavailability of the CLF 22), the Network Attachment can be done between the NACF 24 and the CPE 26, resulting in the corresponding new access information 315 missing in the CLF 22 for a session of a CPE 26. The session may be a Session Initiation Protocol (SIP) session or any IP session that requires access information to be sent to a requesting network node.

The IP address in the CPE 26 and the NACF 24 can be released without notifying the CLF 22. A data recovery of missing access information 315 due to unavailability of the CLF 22 may be performed by a data synchronization by the NACF 24. As previously mentioned, the NACF 24 is the master database of the IP address allocation, which stores the accurate access information of the session when an IP address is reserved or released. However, when the NACF 24 tries to push some messages to the CLF 22 in order to update the access information 302 with the new access information 315 for the session and when there is no response from the CLF 22 because a failure or a maintenance operation occurs at the CLF 22, the NACF 24 stores the undelivered messages (access information 315) and resent them when the CLF 22 recovers. The sending of the messages directed to the CLF 22 is based on the steps performed after the recovery of the CLF 22.

After a certain amount of time, which may vary depending on the importance of the failure or the maintenance operations of the CLF 22, the CLF 22 may recover its network node capabilities for allowing it to perform normal operation as before the unavailability (step 316). A network node, for example a SBC 32, may request location information regarding a session for particular a CPE 26 (request 321, step 320), the CLF 22 then detects that it needs a synchronization of the content of its list 400 (step 324). Thus, the CLF 22 is synchronized only when needed for a particular session and does not need to reload the whole content of the NACF 24.

In particular, the recovery data which corresponds to the access information 315 stored in the NACF 24 during unavailability of the CLF 22 may be retrieved by the SBC 32. When the SBC 32 queries the CLF 22, e.g. for the new location information missing during the failure period of the CLF node 22 the CLF is triggered, while not being limited to, when a request 106 is received at the SBC 32 the CPE 26. Such request 106 sent to the SBC 32 or another network node is, for example, on a request 106 for services or a session initiation request, while not being limited to such request, from the particular CPE 26.

Thus, in order to recover the access information 315 for the session, the CLF 22 sends a request 325 to the NACF 24 (step 328). The request 325 may, for example, while not being limited to, contain the information of table 1 (Bind request).

The Bind Indication information flow contains the following information.

TABLE 1
Bind Indication (CLF -> NACF)

| Globally Unique Address | |
|---|---|
| Assigned IP Address | The IP address allocated to the terminal |
| | equipment. |
| Addressing Realm | The addressing domain in which the IP |
| | address is significant. |

The NACF 24 processes this request and sends an acknowledgment response 329 to the CLF 22. The acknowledgement response 329 includes the access information 315 for the session of the CPE 26, which is stored at the NACF 24 during the unavailability of the CLF 22. The acknowledgement response 329 may, for example, while not being limited to, contain the information of table 2 (Bind Request Acknowledgment).

The Bind Request Acknowledgment information flow contains the following information.

TABLE 2
Bind Request Acknowledgment (NACF -> CLF)

| Globally Unique Address | |
|---|---|
| Assigned IP Address | The IP address allocated to the terminal |
| | equipment. |
| Addressing Realm | The addressing domain in which the IP |
| | address is significant. |
| Physical Access ID | The identity of the physical access to |
| (optional) | which the user equipment is connected |
| Logical Access ID | The identity of the logical access used |
| | by the attached terminal equipment. |
| | (NOTE 1) |
| Terminal Type | The type of terminal equipment. (NOTE 2) |
| (optional) | |

NOTE 1: If the NACF is implemented as a DHCP server, this parameter is mapped to the DHCP option 82, sub-option 1 and 2.
NOTE 2: If the NACF is implemented as a DHCP server, this parameter is mapped to the DHCP option 77.

When receiving the access information 315 (step 332), the CLF 22 updates and synchronizes the list 400 for the session and for the CPE 26 for which the information is related (step 336). The recovery data in the CLF 22 is then consistent with the content (all the pushed messages) stored in the NACF 24 for the session during the period of unavailability of the CLF 22. The CLF 22 ultimately replies to the request received from the SBC 32 by sending the requested information (location information) for the CPE 26 (step 340). Those skilled in the art will appreciate that the same process may be applied to request received from other network node than the SBC 32. It can be understood that the CLF 22 can store access information related to a session for a plurality of CLF 22 in list 400 and is not only limited to the synchronization process of only one session. However, a session is only synchronized when required at the CLF and based on a request received on such session from a network node in the communication node 100.

While the invention has been particularly shown and described with reference to the preferred embodiments thereof, it will be understood by those skilled in the art that various alterations may be made therein without departing from the spirit and scope of the invention.

What is claimed is:

1. A method for supporting a synchronization of a connectivity session location function (CLF) in a communication network, the method comprising steps of:
detecting the unavailability of the CLF;
storing access information related to a session of a user equipment (UE), at a network access configuration function (NACF), during the unavailability of the CLF;
recovering network node capabilities at the CLF;
receiving from a network node a request for retrieving access information for the session of the UE;
detecting that access information related to the session of the UE is missing from the CLF;
sending an access information request to the NACF for retrieving the missing access information for the session of the UE;
receiving an acknowledgement message from the NACF, the acknowledgment message including the missing access information for the session of the UE; and
synchronizing the CLF for the session of the UE.

2. The method of claim 1, wherein the following steps are executed prior the step of detecting:
receiving access information at the CLF, the access information being sent by the NACF; and
storing the received access information in the CLF.

3. The method of claim 1, wherein the step of receiving from a network node a request for retrieving access information comprises a step of sending an IP address allocated to the UE.

4. The method of claim 3, wherein the access information is stored in a memory of the CLF.

5. The method of claim 1, wherein the step of synchronizing comprises the steps of:
updating, based on the content of the received acknowledgement message, a list in a memory of the CLF; and
sending a response to the network node, the response including the requested access information for the session the UE.

6. The method of claim 1, wherein the network node is a session border control (SBC) function.

7. The method of claim 1, wherein the messages transmitted between the CLF and the NACF are transmitted on an a2 interface.

8. The method of claim 1, wherein the messages transmitted between the CLF and the NACF are transmitted on an e4 interface.

9. A network node for synchronizing access information between a network node and a communication network following an unavailability of the network node, the network node comprising:
a processor for sending and receiving messages from a communication network, detecting the unavailability of a connectivity session location function (CLF), detecting that access information related to the session of the UE is missing from the CLF, receiving missing access information for a session of a user equipment (UE) and synchronizing the CLF for the session of the UE; and
wherein the processor accesses a memory for storing access information and synchronizes the stored access information for the session with the received missing access information stored during unavailability of the CLF.

10. The network node of claim 9, wherein the missing access information to be is stored in a Network Access Configuration Function (NACF) during unavailability of the CLF and is transmitted from the NACF to the CLF.

11. The network node of claim 9, wherein the network node further includes an operating system running on the processor, and a corresponding application.

12. The network node of claim 9, wherein the network node an interface unit integrated in the processor.

13. The network node of claim 12, wherein the interface unit allow transmission on an a2 interface.

14. The network node of claim 12, wherein the interface unit allow transmission on an e4 interface.

15. The network node of claim 11, wherein the network node supports a session border control (SBC) function.

16. The network node of claim 11, wherein the network node supports an NACF.
